(19) United States
(12) Patent Application Publication
(10) Pub. No.: US 2007/0135540 A1
(43) Pub. Date: Jun. 14, 2007

(54) Thermoplastic resin composition and injection-molded article thereof

(76) Inventor: Yoshiaki Taguchi, Shizuoka (JP)

Correspondence Address: BUCHANAN, INGERSOLL & ROONEY PC, POST OFFICE BOX 1404, ALEXANDRIA, VA, 22313-1404, US

(21) Appl. No.: 10/576,957

(22) PCT Filed: Oct. 6, 2004
(86) PCT No.: PCT/JP04/14716

§ 371 Date: Apr. 25, 2006

(30) Foreign Application Priority Data
Nov. 5, 2003 (JP) 2003-375254

(51) Int. Cl. C08K 5/52

(52) U.S. Cl. 524/127; 252/299.01; 524/537

(57) ABSTRACT

The present invention provides a thermoplastic resin composition with an excellent mechanical strength, heat resistance and flame-retardant properties and, particularly, is preferably used for a thin-walled molding material. (A) a thermoplastic resin which does not form an anisotropic melt phase 100 weight parts is compounded with (B) a liquid crystalline polymer capable of forming an anisotropic melt phase 15 to 45 weight parts, (C) a flame-retardant component including (C-1) a phosphor-based flame-retardant agent 5 to 20 weight parts and (C-2) a silicone rubber 1 to 15 weight parts, wherein the ratio (C-1)/(C-2) ranges from 1 to 2, and (D) a filler 10 to 80 weight parts.

### TECHNICAL FIELD

The present invention relates to a thermoplastic resin composition which is excellent in mechanical strength, heat resistance and flame retardance and, particularly, can be suitably used as a thin-walled molding material.

### BACKGROUND ART

Liquid crystalline polymers capable of forming anisotropic melt phase are thermoplastic resins having many advantageous characteristics such as high strength, high modulus of rigidity, high heat resistance or good moldability. They have, however, a drawback that they have different values in molding shrinkage rate and mechanical properties between the direction of molecular chain orientation and the vertical direction, and further have a commercial handicap of high price. On the other hand, thermoplastic resins such as polyethylene and polycarbonate which do not form anisotropic melt phase are relatively inexpensive. They are, however, inferior in their physical properties such as modulus and heat resistance to the liquid crystalline polymers, and specifically are insufficient in flowability of the molten resin during the manufacturing process and modulus of the molded articles for use in thin-walled housings. Accordingly, they can not avoid from a thick-walled design, which limits them in coping with the miniaturization of an electric/selectronic product.

Responding to the situation, an attempt is proposed that liquid crystalline polymers and thermoplastic resins are mixed to use in order to utilize their respective advantages and offset their respective drawbacks (Patent literature 1, for example). The miniaturized electric and electronic product, however, is recently used under a higher voltage and a higher current, which requires resin-made parts to have higher flame retardance. Furthermore, these electronic parts are preferably free from a halogen-based flame retardant from the viewpoint of environmental load. To solve these issues, Patent literature 2 proposes a resin composition made of a liquid crystalline polymer, polycarbonate and a phosphate-based flame retardant. Addition of just a phosphate-based flame retardant, however, results in significant lowering in deflection temperature under load, and thus is worse in safety under an environmental condition of higher temperature accompanied with higher voltage. Furthermore, Patent Document 3 proposes a use together with a specified phosphate ester and a specified alkoxy group-containing organopolysiloxane to suppress the lowering in deflection temperature under load. The system for using a liquid crystalline polymer together with them, however, needs a high temperature to process, causing a problem that they are processed, particularly molded to generate a gas with which a mold deposit is generated on a mold.

Patent literature 1: JP-A 8-118398

Patent literature 2: JP-A 9-143357

Patent literature 3: JP-A 2002-235012

### DISCLOSURE OF THE INVENTION

### PROBLEMS TO BE SOLVED BY THE INVENTION

An object of the present invention is to improve the imperfections in the above-described related art, thus to provide a thermoplastic resin composition which is excellent in mechanical strength, heat resistance, and flame retardance, and can be suitably used specifically as a material for thin-walled molding.

### MEANS TO SOLVE THE PROBLEMS

To achieve the above object, the present inventors conducted a diligent study, and found that a flame-retardant component made of a phosphor-based flame retardant, a silicone rubber and a filler are essentially compounded with a resin component made of a thermoplastic resin and a liquid crystalline polymer to prepare a thermoplastic resin composition for injection molding, and that the phosphor-based flame retardant and the silicone rubber are compounded at a specified ratio to provide high heat resistance and excellent flame retardance, thereby to furnish a thin-walled molded article specifically with excellent mechanical strength, heat resistance, and flame retardance. The findings have completed the present invention.

Accordingly, the present invention provides a thermoplastic resin composition, prepared by compounding 100 parts by weight of (A) a thermoplastic resin which does not form an anisotropic melt phase, 15 to 45 parts by weight of (B) a liquid crystalline polymer which can form an anisotropic melt phase, (C) a flame-retardant component containing 5 to 20 parts by weight of (C-1) a phosphor-based flame-retardant and 1 to 15 parts by weight of (C-2) a silicone rubber, and 10 to 80 parts by weight of (D) a filler, wherein a ratio (C-1)/(C-2) ranges from 1 to 2; and an injection-molded article containing the thermoplastic resin composition, specifically an injection-molded article for a thin-walled housing.

### EFFECT OF THE INVENTION

The thermoplastic resin composition according to the present invention provides a thermoplastic resin injection-molded article with excellent flame retardance, mechanical characteristics, heat resistance, and other characteristics. Furthermore, the composition can provide the molded article accompanied with almost no mold deposit. The molded article, which has advantageous characteristics of very high modulus of rigidity, high strength, and excellent flame retardance, is suitable for thin-walled molded article for electric and electronic parts, particularly for casing of personal computer and the like, frame of LCD, and the like.

### BEST MODE FOR CARRYING OUT THE INVENTION

The present invention is described below in detail. (A) the thermoplastic resin which does not form anisotropic melt phase used in the present invention includes: polyolefin (co)polymer such as polyethylene, polypropylene or poly-4-methyl-1-pentene; polyalkylene terephthalate (co)polymer such as polyethylene terephthalate or polybutylene terephthalate; polyester resin such as polycarbonate (co)polymer or amorphous polyarylate resin; polyamide (co)polymer; ABS resin; polyarylene sulfide (co)polymer; polyacrylate; polyacetal (co)polymer; a resin composed mainly of the above resins; and a copolymer composed of monomer units structuring above (co)polymers. Above resins may be used alone or in combination of two or more thereof. Among these, preferable ones in view of heat resistance are: polyester resin such as polycarbonate resin, polybutylene terephthalate resin or polyethylene terephthalate resin; and polyarylene sulfide resin. From the viewpoint of cost and balance in physical properties such as specific gravity, flowability or flexural property, the aromatic polycarbonate resin is particularly preferred.

(B) the liquid crystalline polymer used in the present invention signifies a melt-processable polymer having the property to form an optically anisotropic melt phase, a property that the polymer is melt under a shear stress to allow the polymer molecular chains to take a regularly parallel arrangement. Such a polymer molecule is generally thin and flat, and exhibits very high modulus along the longitudinal direction of the molecule. The polymer generally has a plurality of chain-extension bonds which have relation with each others in a coaxial or parallel position. The property of anisotropic melt phase can be identified by an ordinary polarization test utilizing crossed polarizers. More specifically, the anisotropic melt phase can be identified by observing a melt sample which is put on the Leitz hot stage under a nitrogen gas atmosphere to inspect at a magnification of ×40 using a Leitz polarization microscope. The liquid crystalline polymer applicable to the present invention, even if it is on a melt and stationary state, is inspected between crossed polarizers normally to transmit polarization light, indicating that it is optically anisotropic.

(B) the liquid crystalline polymer described above is preferably, but is not specifically limited to, an aromatic polyester or an aromatic polyester amide, and includes a polyester which contains partially an aromatic polyester or an aromatic polyester amide in the same molecule chain. These polymers preferably have an inherent viscosity number (I.V.) of at least about 2.0 dl/g, more preferably 2.0 to 10.0 dl/g, when it is dissolved in pentafluorophenol at 60° C. to have a concentration of 0.1% by weight.

Specifically preferred aromatic polyester or aromatic polyester amide as (B) the liquid crystalline polymer applicable to the present invention is an aromatic polyester or an aromatic polyester amide which contains at least one compound selected from the group consisting of an aromatic hydroxycarboxylic acid, an aromatic hydroxyamine, and an aromatic diamine as the construction unit.

More specifically, p0 (1) a polyester composed mainly of one or more of aromatic hydroxycarboxylate and a derivative thereof;
(2) a polyester composed mainly of (a) one or more of aromatic hydroxycarboxylate and a derivative thereof, (b) one or more of aromatic dicarboxylate, alicyclic dicarboxylate, and a derivative thereof, and (c) one or more of aromatic diol, alicyclic diol, aliphatic diol, and a derivative thereof;
(3) a polyester amide composed mainly of (a) one or more of aromatic hydroxycarboxylate and a derivative thereof, (b) one or more of aromatic hydroxyamine, aromatic diamine, and a derivative thereof, and (c) one or more of aromatic dicarboxylate, alicyclic dicarboxylate, and a derivative thereof; and
(4) a polyester amide composed mainly of (a) one or more of aromatic hydroxycarboxylate and a derivative thereof, (b) one or more of aromatic hydroxyamine, aromatic diamine, and a derivative thereof, (c) one or more of aromatic dicarboxylate, alicyclic dicarboxylate, and a derivative thereof, and (d) one or more of aromatic diol, alicyclic diol, aliphatic diol, and a derivative thereof may be proposed. A molecular weight adjuster may further be added to the above construction components if necessary.

Preferred examples of the compound structuring (B) the liquid crystalline polymer applicable to the present invention include: an aromatic hydroxycarboxylic acid such as p-hydroxybenzoic acid or 6-hydroxy-2-naphthoic acid; an aromatic diol such as 2,6-dihydroxynaphthalene, 1,4-dihydroxynaphthalene, 4,4′-dihydroxybiphenyl, hydroquinone, resorcin or compounds represented by the following formula (I) and the following formula (II); aromatic dicarboxylic acid such as terephthalic acid, isophthalic acid, 4,4′-diphenyldicarboxylic acid, 2,6-naphthalene dicarboxylic acid or compounds represented by the following formula (III); and aromatic amine such as p-aminophenol or p-phenylene diamine.

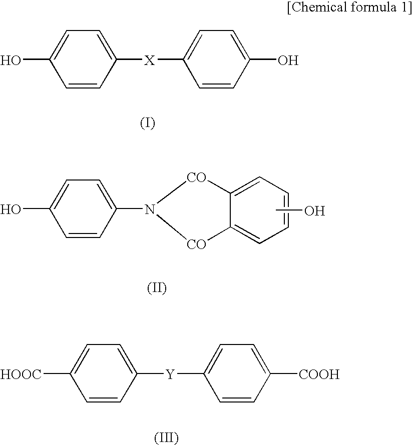

(wherein X is a group selected from alkylene (C₁ to C₄), alkylidene, —O—, —SO—, —SO₂—, —S— and —CO—; and Y is a group selected from —(CH₂)ₙ— (n=1 to 4) and —O(CH₂)ₙO— (n=1 to 4)).

A specifically preferred (B) liquid crystalline polymer applicable to the present invention is an aromatic polyester containing p-hyroxybenzoic acid and 6-hydroxy-2-naphthoic acid as the main structure units.

The amount of (B) the liquid crystalline polymer added is from 15 to 45 parts by weight relative to 100 parts by weight of (A) the thermoplastic resin. (B) the liquid crystalline polymer added at an amount of less than 15 parts by weight gives an article with a small improvement in mechanical properties, particularly in modulus, while the polymer added at an amount of larger than 45 parts by weight gives the article with an unfavorable cost and a small improvement in mechanical properties relative to the amount.

The (C-1) phosphor-based flame retardant used in the present invention includes monomer-type phosphoric acid ester such as phosphate, phosphite or phosphinate, and polymer-type phosphoric acid ester.

Examples of the monomer-type phosphoric acid ester are: aliphatic phosphate such as tri-C₁₋₁₀ alkyl phosphate including trimethyl phosphate, triethyl phosphate, tripropyl phosphate, triisopropyl phosphate, tributyl phosphate and triisobutyl phosphate, and di-C₁₋₁₀ alkyl phosphate and mono-C₁₋₁₀ alkyl phosphate corresponding to the above triphosphate; aromatic phosphate including tri-C₆₋₂₀ aryl phosphate such as triphenyl phosphate, tricresyl phosphate, trixylyl phosphate, diphenyl cresyl phosphate, tri(isopropylphenyl) phosphate or diphenyl ethyl cresyl phosphate; and aliphatic-aromatic phosphate such as methyl diphenyl phosphate or phenyl diethyl phosphate.

As the polymer-type phosphoric acid ester, a condensed phosphate can be applied. The condensed phosphate includes the one having aromatic ring, and, for example, the one having the construction unit represented by the formula (1) is preferred.

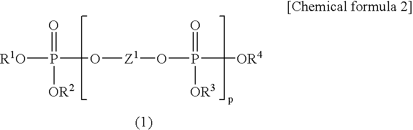

(wherein, R¹ to R⁴ are each an aryl group which may have a substituent; Z¹ is a divalent aromatic group; and p is an integer between 1 and 5.) p In the formula (1), as the aryl group represented by R¹ to R⁴, a C₆₋₂₀ aryl group such as phenyl group or naphthyl group may be proposed. As the substituent for the aryl group, an alkyl group such as methyl group or ethyl group may be proposed. Further, as the divalent aromatic group represented by Z¹, an arylene group such as C₆₋₂₀ arylene group including phenylene group and naphthylene group; biphenylene group; and bisphenol residue such as bis(hydroxyaryl)alkane residue including bisphenol-A residue, bisphenol-D residue and bisphenol-AD residue, bisphenol-F residue or bisphenol-S residue may be proposed.

Examples of the condensed phosphate ester represented by the formula (1) are: resorcinol phosphate such as resorcinol bis(diphenyl phosphate), resorcinol bis(dicresyl phosphate) or resorcinol bis (dixylenyl phosphate); hydroquinone phosphate, biphenol phosphate and biphenol-A phosphate, corresponding to the above resorcinol phosphates.

As of these, the polymer-type phosphoric acid ester is preferred in view of the amount of gas generated in the processing stage, and specifically preferred one is resorcinol bis(diphenyl phosphate).

The amount of (C-1) the phosphor-based flame retardant added is from 5 to 20 parts by weight, preferably from 8 to 17 parts by weight, relative to 100 parts by weight of (A) the thermoplastic resin. (C-1) the phosphor-based flame retardant added at an amount of less than 5 parts by weight gives an article with an insufficient effect of flame retardance, while the flame retardant added at an amount of larger than 20 parts by weight generates an increased gas during the processing stage and significantly lowers a deflection temperature under load.

The (C-2) silicone rubber used in the present invention is preferably a powdery granule, and a silicone rubber prepared by crosslinking organopolysiloxane, that is a silicone rubber prepared by thermal crosslinking with a curing agent blended or by crosslinking at least one kind of organopolysiloxanes having a group which is reacted by heating or irradiation with ultraviolet light in the presence of catalyst to react. Specifically preferred one is an additive type granular or powdery silicone rubber crosslinked by hydrosililation addition reaction between an unsaturated group such as vinyl group and —Si—H in the presence of a platinum compound catalyst. From the viewpoint of heat resistance, the preferred silicone rubber is prepared by crosslinking an organopolysiloxane having a viscosity of ten thousand centistokes or more, particularly fifty thousand centistokes or more. That kind of silicone rubber may be commercially available. The granular or powdery silicone rubber preferably has an average particle size of from 0.1 to 100 μm, and more preferably from 1 to 20 μm.

The amount of (C-2) the silicone rubber added is from 1 to 15 parts by weight relative to 100 parts by weight of (A) the thermoplastic resin, preferably from 1 to 10 parts by weight, and more preferably from 2 to 8 parts by weight. (C-2) the silicone rubber added at an amount of less than 1 part by weight gives an article with insufficient effect of flame retardance, while the rubber added at an amount of larger than 15 parts by weight gives the article with an unfavorable cost.

The phosphor-based flame retardant (C-1) and the silicone rubber (C-2) are added at a weight ratio [(C-1)/(C-2)] of from 1 to 2. The addition without the range results in small effect of flame retardance.

The (D) filler used in the present invention is an inorganic filler in a shape of fiber, powder, granule, plate, or the like. Examples of (D) the filler are: glass fiber; carbon fiber; potassium titanate fiber; carbon milled fiber; rock wool; inorganic fiber such as that of zirconia, alumina silica, potassium titanate, barium titanate, titanium oxide, silicon carbide, alumina, silica, and blast furnace slag; fibrous wollastonite; whisker such as silicon nitride whisker, silicon trinitride whisker, basic magnesium sulfate whisker, barium titanate whisker, silicon carbide whisker or boron whisker; metallic fiber such as that of mild steel, stainless steel, copper and its alloy, brass, aluminum and its alloy, and lead; gypsum fiber; ceramics fiber; mica; talc; silica; calcium carbonate; glass beads; glass flake; glass microballoon; clay; wollastonite; and titanium oxide.

The (D) filler is preferably a combination of one or more fillers, and one of them is preferably glass fiber in view of performance. Applicable glass fiber includes ordinary glass fiber, glass fiber with metallic coating of nickel, copper, and the like, and silane fiber. As of these, specifically preferred one is glass fiber having an average fiber diameter of from 5 to 20 μm and having an average aspect ratio of 15 or more. Two or more kinds of fibrous filler may be applied.

The amount of (D) the filler added is from 10 to 80 parts by weight, preferably from 30 to 70 parts by weight, relative to 100 parts by weight of (A) the thermoplastic resin. (D) the filler added at an amount of less than 10 parts by weight is insufficient in effect for improving the mechanical performance, particularly modulus, while the filler added at an amount of larger than 80 parts by weight significantly lowers the flowability.

In the present invention, preferably (E) a dispersing agent is further added. The preferable (E) dispersing agent is a phosphorus compound such as, as exemplified in JP-A 2001-26698, a phosphonate compound, a phosphinate compound, a phosphonite compound, a phosphinite compound, and an organic phosphorus compound containing these structural moieties within the molecule.

Particularly preferred ones are phosphorus oxo acid monoester or a phosphorus oxo acid diester, represented by the formulae (a) and (b):
(X)ₘP(═O)(OR)₃₋ₘ (a)
(X)ₘP(OR)₃₋ₘ (b)
wherein: X is a hydrogen atom, a hydroxyl group or a monovalent organic group, and plurality of X may be the same as or different from each other; R is a monovalent organic group, and plurality of R may be the same as or different from each other; and m is an integer of 1 or 2.

The amount of (E) the dispersing agent added is from 0.1 to 1 part by weight, preferably from 0.2 to 0.7 parts by weight, relative to 100 parts by weight of (A) the thermoplastic resin. (E) the dispersing agent added at an amount of less than 0.1 part by weight is insufficient to exhibit the dispersion effect, thereby likely to reduce significantly the thin-wall modulus, while the dispersing agent added at an amount of more than 1 part by weight is processed to generate a significantly increased gas, which generates a mold deposit in the injection molding step.

In the present invention, preferably (F) a fluorine-based resin is further added. The (F) fluorine-based resin referred to herein includes: a polymer or a copolymer of a fluorine-containing monomer such as tetrafluoroethylene, chlorotrifluoroethylene, vinylidene fluoride, hexafluoropropylene or perfluoroalkyl vinylether; and a copolymer of the above fluorine-containing monomer with a copolymerizable monomer such as ethylene, propylene or (meth)acrylate. Examples of that kind of the fluorine-based resin are: a polymer such as polytetrafluoroethylene, polychlorotrifluoroethylene or polyvinylidene fluoride; and a copolymer such as a tetrafluoroethylene-hexafluoropropylene copolymer, a tetrafluoroethylene-perfluoroalkyl vinylether copolymer, an ethylene-tetrafluoroethylene copolymer or an ethylene-chlorofluoroethylene copolymer. Regarding those fluorine-based resins, the one having a suitable polymerization degree may be selected responding to the objectives such as dispersibility of resin and processability of obtained composition. Although one or more of these fluorine-based resins can be blended to use, polytetrafluoroethylene is preferred.

Manufacturing of polytetrafluoroethylene is not specifically limited. A preferable powder of polytetrafluoroethylene is, however, prepared by suspension polymerization followed by pulverizing the solidified substance. The powder prepared by suspension polymerization followed by pulverization has a narrow particle size distribution, is free from agglomerate, and can be dispersed in the composition. To the contrary, the polytetrafluoroethylene prepared by emulsion polymerization contains agglomerate, has a wide particle size distribution, and can not be dispersed uniformly in the composition compared with the powder of suspension polymerization. The polytetrafluoroethylene according to the present invention includes, in addition to a tetrafluoroethylene polymer, a tetrafluoroethylene-hexafluoropropylene copolymer, a tetrafluoroethylene-perfluoroalkoxyethylene copolymer, a trifluoroethylene copolymer, and a tetrafluoroethylene-ethylene copolymer.

The amount of (F) the fluorine-based resin added is preferably from 0.1 to 1 part by weight, more preferably from 0.2 to 0.7 parts by weight, relative to 100 parts by weight of (A) the thermoplastic resin. (F) the fluorine-based resin added at an amount of less than 0.1 part by weight is insufficient to give a non-dropping effect during burning, while the resin added at an amount of larger than 1 part by weight causes insufficient dispersion of the fluorine-based resin, which may result in a white spot appearing on the surface of a molded article.

The thermoplastic resin composition according to the present invention may further contain an additive including a nucleus, a pigment such as carbon black, an antioxidant, a stabilizer, a plasticizer, a lubricant and a releasing agent to provide the article with desired characteristics. Those kinds of compositions are also included in the thermoplastic resin composition according to the present invention.

From the thermoplastic resin composition according to the present invention, a molded article is obtained using a known molding method. Among various methods for molding to obtain the molded article, an ordinary injection molding machine is preferably used to mold. This injection molding promotes to form the anisotropy of (B) the liquid crystalline polymer which is capable of forming an anisotropic melt phase in the thermoplastic resin composition according to the present invention and makes the polymer (B) fibrilliform.

Since the thermoplastic resin composition according to the present invention, which has advantageous characteristics including a high deflection temperature under load, a high thin-wall modulus, and flame retardance, is particularly preferred to use for molding a thin-walled housing. Examples of the applicable thin-walled housing are a casing for a portable terminal such as notebook PC, a mobile phone or a digital still camera, and a chassis for reading on an optical digital disc such as CD, CD-R or DVD.

### EXAMPLES

The present invention is described below in detail referring to the examples. The examples, however, do not limit the scope of the present invention. The applied evaluation methods and variables for the injection-molded article are as follows.

(Flammability Test)

The flammability test was given in accordance with UL94. The flammability was evaluated on a 0.8 mm thick test piece.

(Thin-Wall Modulus Test)

As the thin-wall modulus test, flexural modulus (FM) was measured on a 0.8 mm thick test piece by a similar method as specified in ISO178.

(Deflection Temperature Under Load)

The deflection temperature under load was measured under 1.8 MPa load in accordance with the method as specified in ISO75-1 and 2.

(Mold Deposit)

During molding the UL test pieces, successive molding of 250 shots was given, and the mold deposit was visually observed. The judgment is as follows.
◯: The surface of a mold after molding is almost equal to that before molding.
Δ: The surface of a mold after molding is visually clean, but is lightened by a flashlight to appear white.
×: The surface of a mold after molding appears visually white.

### Examples 1 to 4

The components given below of their respective amounts shown in Tables 1 and 2 were added to 100 parts by weight of a polycarbonate resin. The mixture was melted and kneaded at a resin temperature (a set cylinder temperature) of 300° C. in a 30 mm diametric twin-screw extruder to prepare pellets. The pellets were then molded at a molding temperature of 300° C. (a set cylinder temperature) and at a mold temperature of 70° C. by an injection molding machine to prepare test pieces corresponding to their respective tests.

The molding conditions are as follows.

Molding machine: JSW J75SSII-A

Cylinder temperature: 300-300-290-280° C.

Injection speed: 2 m/min

Dwelling force: 58.8 MPa

Cycle: Injection and dwelling 10 sec+Cooling 15 sec

Screw rotation speed: 100 rpm

Screw backpressure: 3.5 MPa

### Comparative Examples 1 to 8

Test pieces were similarly prepared to evaluate as in Examples, but they had a ratio [(C-1)/(C-2)] of without the range of the present invention, or used silicone oil instead of (C-2) the silicone rubber, as shown in Tables 1 and 2.

The results are shown in Tables 1 and 2.

Details of the applied components are as follows.

(A) Thermoplastic resin:

Polycarbonate resin (Panlite L1225L, Teijin Chemicals, Ltd.)

(B) Liquid crystalline polymer:

Liquid crystalline polyester (Vectra A950, Polyplastics Co., Ltd.)

(C-1) Phosphorus-based flame retardant:

(C-1)-1: PX200, Daihachi Chemical Industry Co., Ltd.

(C-1)-2: SONGFLA TP-100, SONGWON INDUSTRIAL CO., LTD.

(C-2) Silicone rubber:

(C-2)-1: DY33-310, Dow Corning Toray Company, Limited.

(C-2)-2: Silicone oil (Comparative component, KF-54, Shin-Etsu Silicone Co., Ltd.)

(D) Filler:

Glass fiber (CS03JA416, Asahi Fiber-Glass Co., Ltd.)

(E) Dispersing agent:

JP-218SS, Johoku Chemical Co., Ltd.

(F) Fluorine-based resin:

Polytetrafluoroethylene (800J, DUPONT-MITSUIMitsui DuPont POLYCHEMICALS Co., Ltd.)

Lubricant:

UNISTAR H-476, NOF Corporation

TABLE 1

| | | Comparative | Comparative | Comparative | | | Comparative |
|---|---|---|---|---|---|---|---|
| | | Example 1 | Example 2 | Example 3 | Example 1 | Example 2 | Example 4 |
| (A) | (parts by weight) | 100 | 100 | 100 | 100 | 100 | 100 |
| (B) | (parts by weight) | 29 | 31 | 32 | 31 | 31 | 31 |
| (C-1)-1 | (parts by weight) | 5 | 10 | 16 | 8 | | 5 |
| (C-1)-2 | (parts by weight) | | | | | 8 | |
| (C-2)-1 | (parts by weight) | 1 | 1 | 1 | 4 | 4 | 6 |
| (C-2)-2 | (parts by weight) | | | | | | |
| (C-1)/(C-2) | | 5 | 10 | 16 | 2 | 2 | 0.8 |
| (D) | (parts by weight) | 58 | 61 | 65 | 61 | 61 | 61 |
| (E) | (parts by weight) | 0.4 | 0.4 | 0.4 | 0.4 | 0.4 | 0.4 |
| (F) | (parts by weight) | 0.4 | 0.4 | 0.4 | 0.4 | 0.4 | 0.4 |
| Lubricant | (parts by weight) | 0.6 | 0.6 | 0.6 | 0.6 | 0.6 | 0.6 |
| UL flammability test | | HB | HB | HB | V-1 | V-0 | HB |
| Deflection temperature | (° C.) | 127 | 114 | 103 | 120 | 126 | 126 |
| under load | | | | | | | |
| Thin-wall modulus | (Mpa) | 11000 | 12000 | 12000 | 12000 | 12000 | 12000 |
| Mold deposit | | ◯ | ◯ | ◯ | ◯ | ◯ | ◯ |

TABLE 2

| | | | Comparative | | Comparative | Comparative | Comparative |
|---|---|---|---|---|---|---|---|
| | | Example 3 | Example 5 | Example 4 | Example 6 | Example 7 | Example 8 |
| (A) | (parts by weight) | 100 | 100 | 100 | 100 | 100 | 100 |
| (B) | (parts by weight) | 32 | 32 | 36 | 30 | 30 | 30 |
| (C-1)-1 | (parts by weight) | 11 | 5 | 18 | 15 | | 15 |
| (C-1)-2 | (parts by weight) | | | | | | |
| (C-2)-1 | (parts by weight) | 6 | 12 | 13 | | 15 | |
| (C-2)-2 | (parts by weight) | | | | | | 15 |
| (C-1)/(C-2) | | 1.8 | 0.4 | 1.4 | — | — | 1 |
| (D) | (parts by weight) | 65 | 65 | 73 | 75 | 75 | 75 |
| (E) | (parts by weight) | 0.4 | 0.4 | 0.4 | 0.4 | 0.4 | 0.4 |
| (F) | (parts by weight) | 0.4 | 0.4 | 0.4 | 0.4 | 0.4 | 0.4 |
| Lubricant | (parts by weight) | 0.6 | 0.6 | 0.7 | 0.6 | 0.6 | 0.6 |
| UL flammability test | | V-0 | HB | V-0 | HB | HB | HB |
| Deflection temperature | (° C.) | 113 | 125 | 99 | 105 | 139 | 113 |
| under load | | | | | | | |
| Thin-wall modulus | (Mpa) | 11000 | 10000 | 13000 | 12000 | 11000 | 13000 |
| Mold deposit | | ◯ | Δ | Δ | ◯ | Δ | X |

1. A thermoplastic resin composition, prepared by compounding 100 parts by weight of (A) a thermoplastic resin which does not form an anisotropic melt phase, 15 to 45 parts by weight of (B) a liquid crystalline polymer which can form an anisotropic melt phase, (C) a flame-retardant component comprising 5 to 20 parts by weight of (C-1) a phosphor-based flame-retardant and 1 to 15 parts by weight of (C-2) a silicone rubber, and 10 to 80 parts by weight of (D) a filler, wherein a ratio (C-1)/(C-2) ranges from 1 to 2.

2. The thermoplastic resin composition according to claim 1, wherein (C-1) the phosphor-based flame-retardant is a phosphate ester represented by the following formula (1): 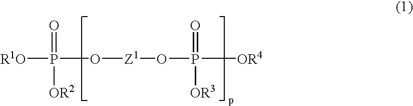
(wherein R¹ to R⁴ are each an aryl group which may have a substituent group; Z¹ is a divalent aromatic group; and p is an integer of 1 to 5).

3. The thermoplastic resin composition according to claim 1, wherein (C-2) the silicone rubber is a silicone rubber formed by cross-linking organopolysiloxane.

4. The thermoplastic resin composition according to claim 1, wherein (C-2) the silicone rubber has an average particle diameter ranging from 1 to 20 μm.

5. The thermoplastic resin composition according to claim 1, further compounding 0.1 to 1 part by weight of (E) a dispersing agent relative to 100 parts by weight of (A) the thermoplastic resin.

6. The thermoplastic resin composition according to claim 5, wherein (E) the dispersing agent is a phosphorus oxo acid monoester or a phosphorus oxo acid diester.

7. The thermoplastic resin composition according to claim 1, wherein (A) the thermoplastic resin is a polycarbonate resin.

8. The thermoplastic resin composition according to claim 1, further compounding 0.1 to 1 part by weight of (F) a fluorine-based resin relative to 100 parts by weight of (A) the thermoplastic resin.

9. The thermoplastic resin composition according to claim 1, wherein at least one of (D) the filler is a glass fiber.

10. An injection-molded article comprising the thermoplastic resin composition according to claim 1.

11. An injection-molded article for a thin-walled housing comprising the thermoplastic resin composition according to claim 1.

12. The thermoplastic resin composition according to claim 2, wherein (C-2) the silicone rubber is a silicone rubber formed by cross-linking organopolysiloxane.

13. The thermoplastic resin composition according to claim 2, wherein (C-2) the silicone rubber has an average particle diameter ranging from 1 to 20 μm.

14. The thermoplastic resin composition according to claim 3, wherein (C-2) the silicone rubber has an average particle diameter ranging from 1 to 20 μm.

15. The thermoplastic resin composition according to claim 2, further compounding 0.1 to 1 part by weight of (E) a dispersing agent relative to 100 parts by weight of (A) the thermoplastic resin.

16. The thermoplastic resin composition according to claim 2, wherein (A) the thermoplastic resin is a polycarbonate resin.

17. The thermoplastic resin composition according to claim 2, further compounding 0.1 to 1 part by weight of (F) a fluorine-based resin relative to 100 parts by weight of (A) the thermoplastic resin.

18. The thermoplastic resin composition according to claim 2, wherein at least one of (D) the filler is a glass fiber.

19. An injection-molded article comprising the thermoplastic resin composition according to claim 2.

20. An injection-molded article for a thin-walled housing comprising the thermoplastic resin composition according to claim 2.
